(19) United States
(12) Patent Application Publication
(10) Pub. No.: US 2011/0148087 A1
(43) Pub. Date: Jun. 23, 2011

(54) Functional Cover for Powered Pallet Jack/Truck

(76) Inventor: Howard Rosenkranz, Palm Beach Gardens, FL (US)

(21) Appl. No.: 12/643,678

(22) Filed: Dec. 21, 2009

(51) Int. Cl. B62D 25/00

(52) U.S. Cl. 280/770

(57) ABSTRACT

A powered pallet jack is used for moving around various types of materials, typically, but not always on pallets. The powered pallet jacks are sometimes used in environments where the electrical system used to run the powered pallet jack can be damaged. The functional cover is constructed of numerous materials with access panels in key locations that allow for an operator to use and utilize all functions of the powered pallet jack while the cover is encapsulated the powered pallet jack. The cover has transparent/translucent flexible plastic portions to allow the operator to see all controls, indicator lights, safety functions. The cover also has reinforced non-transparent portions made up of rigid plastic, flexible plastic and rubber where the powered pallet truck typically receives the largest amount of physical abuse. The access panels are positioned on the cover to match the Manufacturer and Model of the pallet truck being covered. The access panels use Velcro, snaps or other similar sealing methods to achieve a watertight seal. The cover has modular components, allowing for differences in the pallet jack construction. These modular components are held together with zippers.

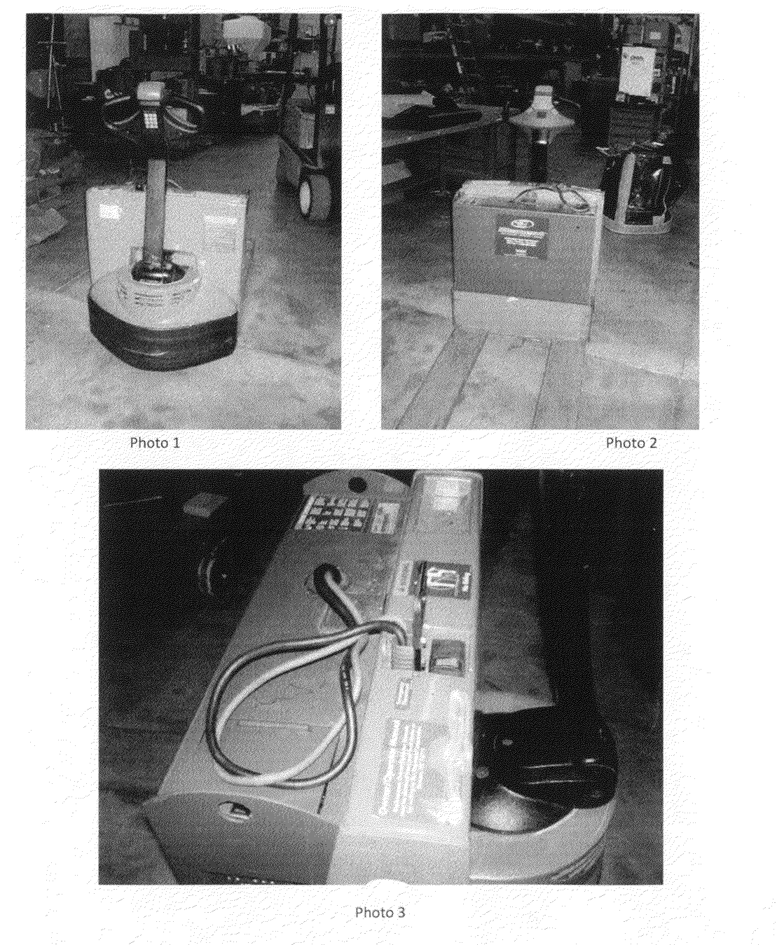

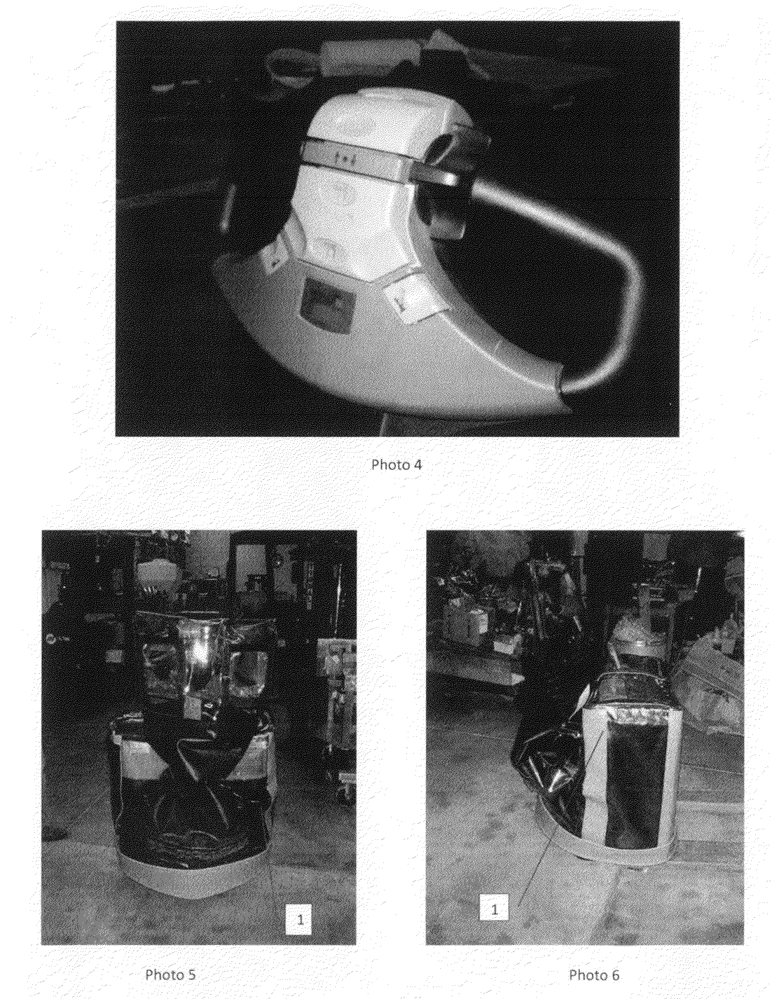

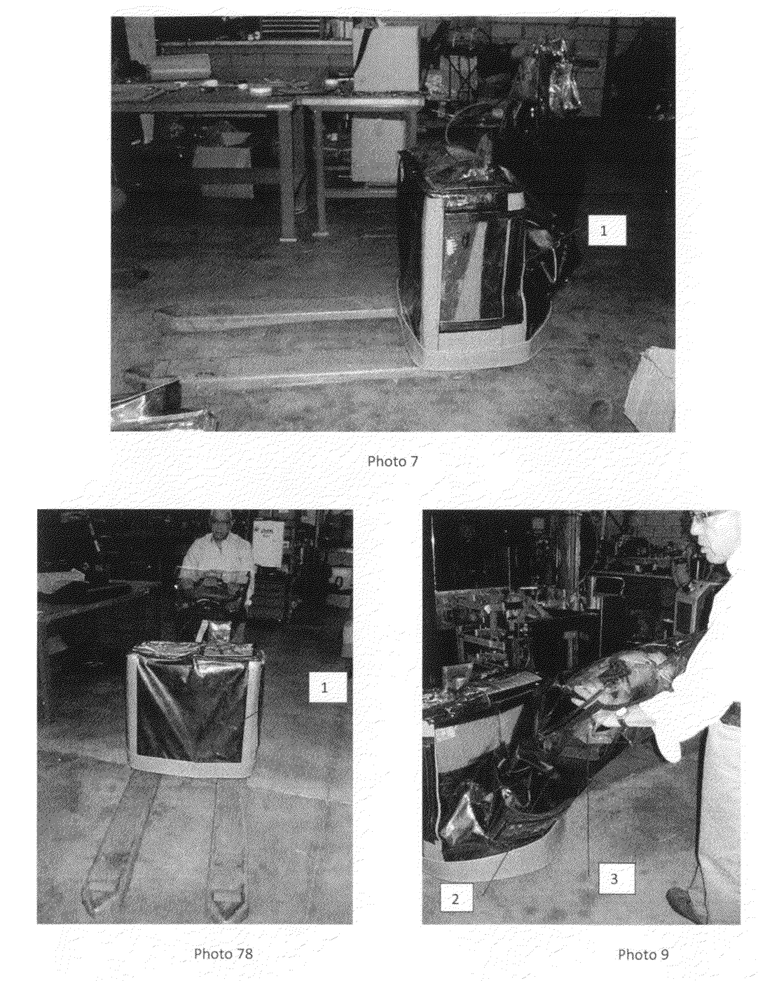

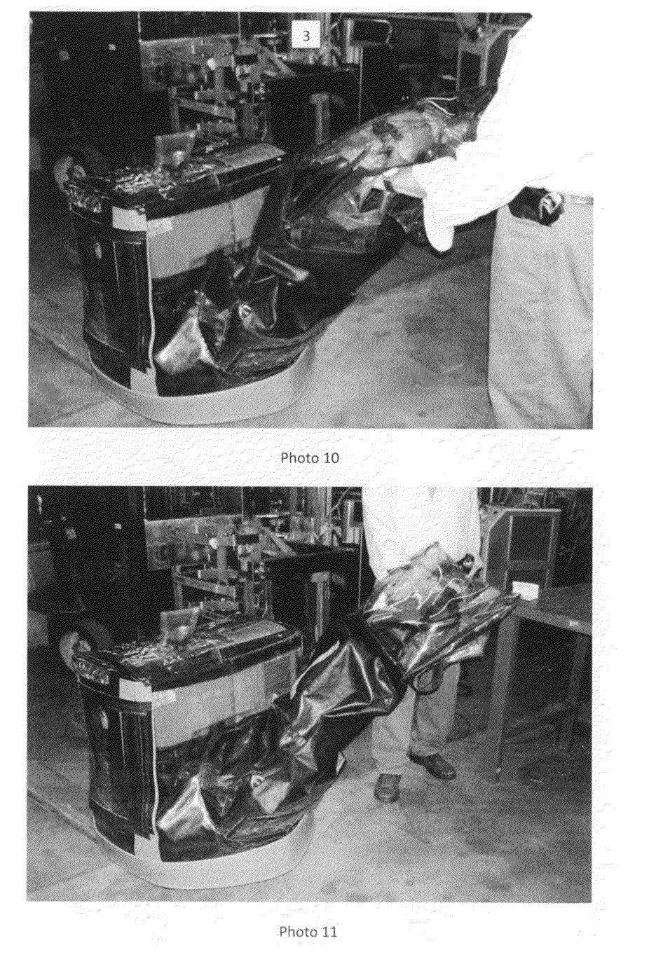

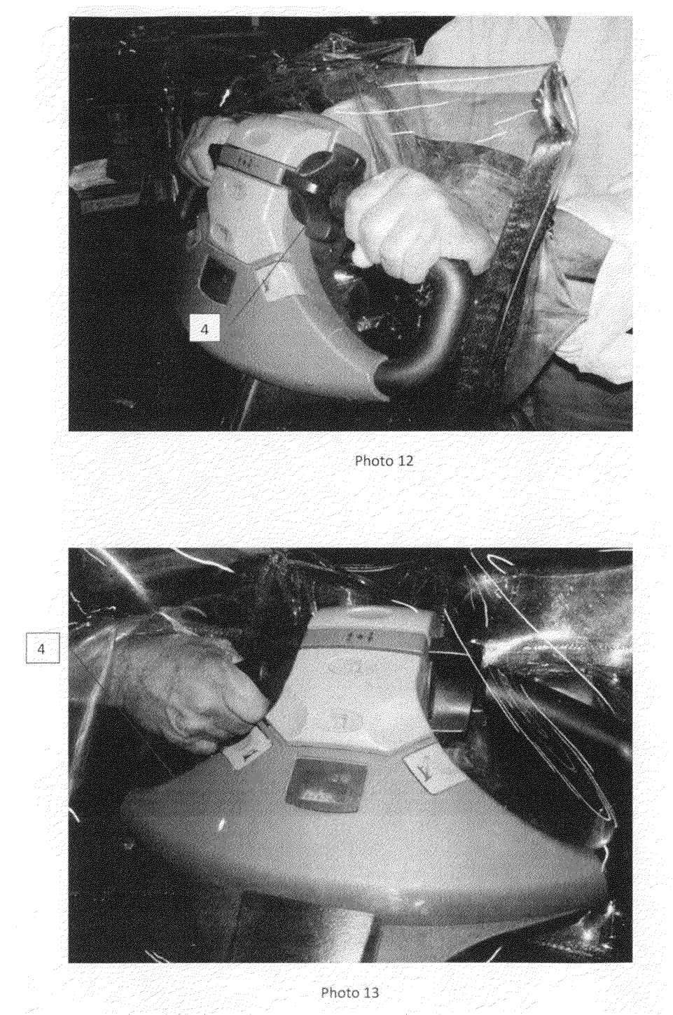

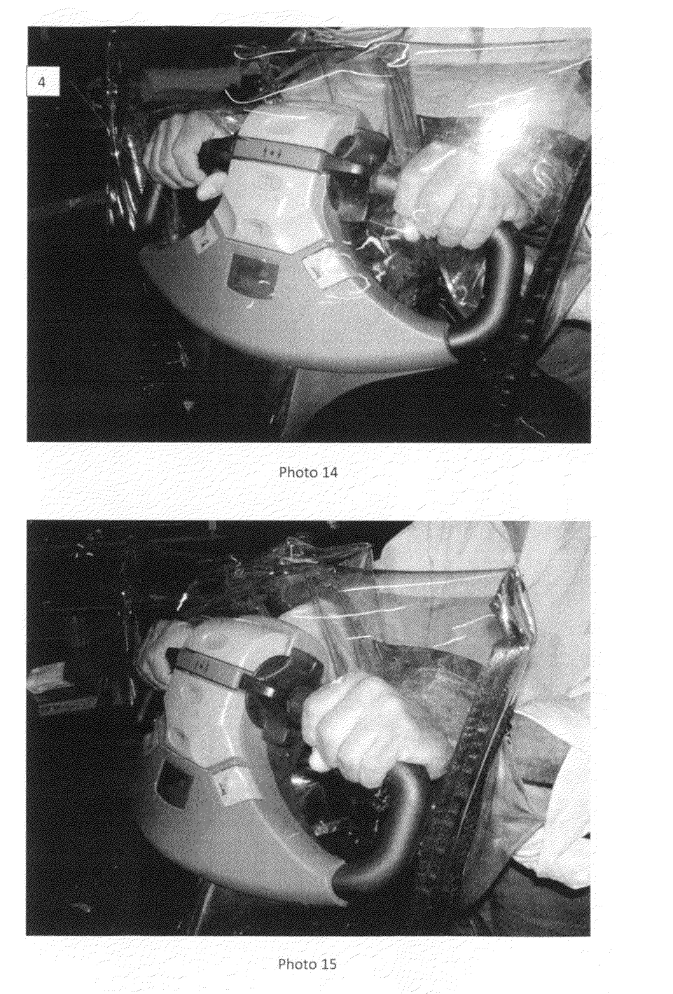

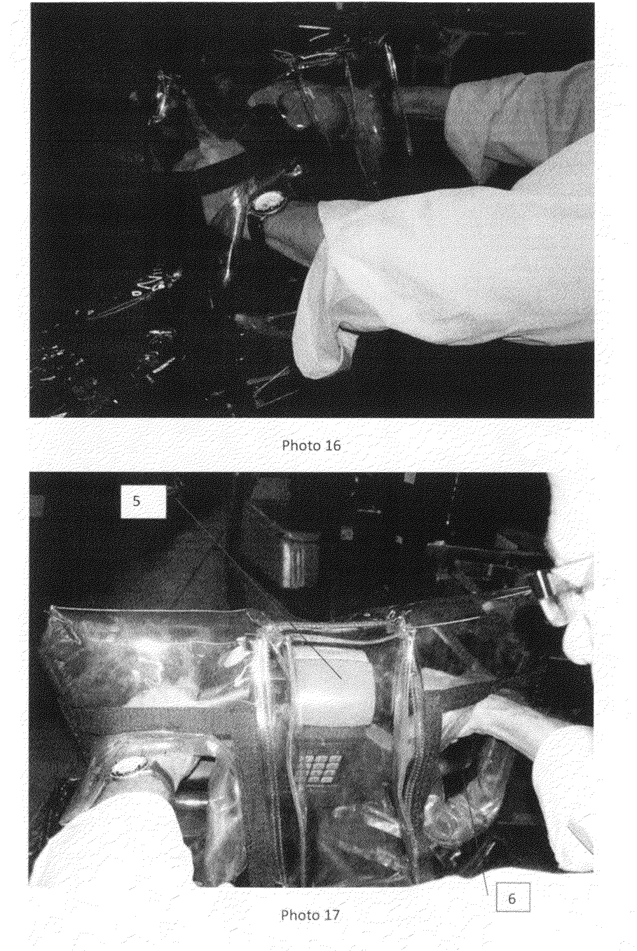

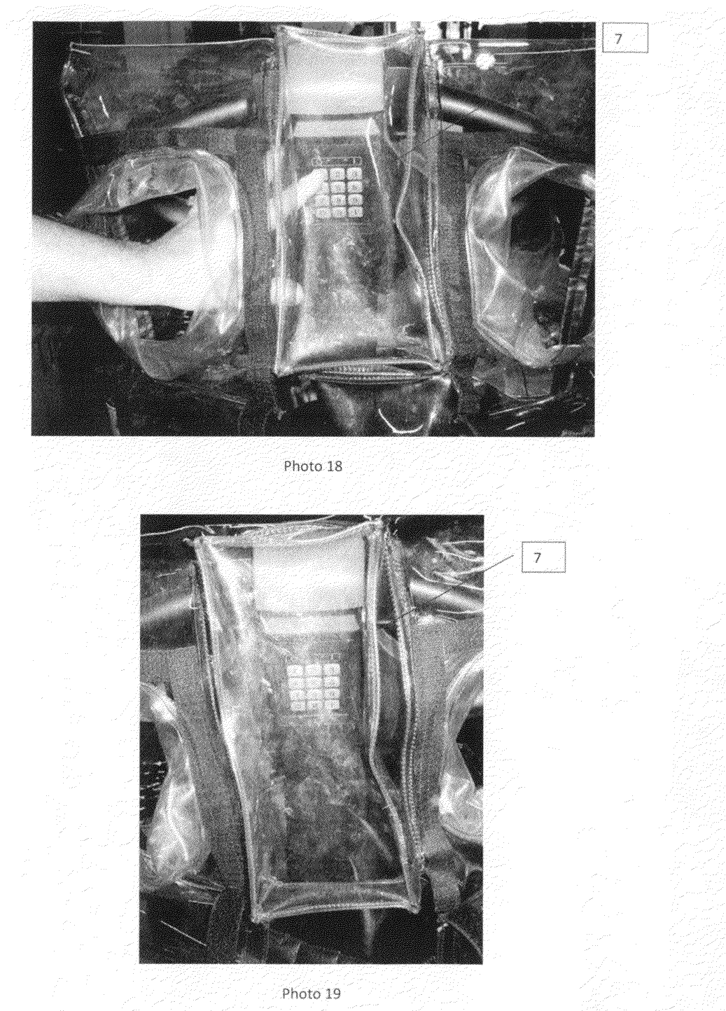

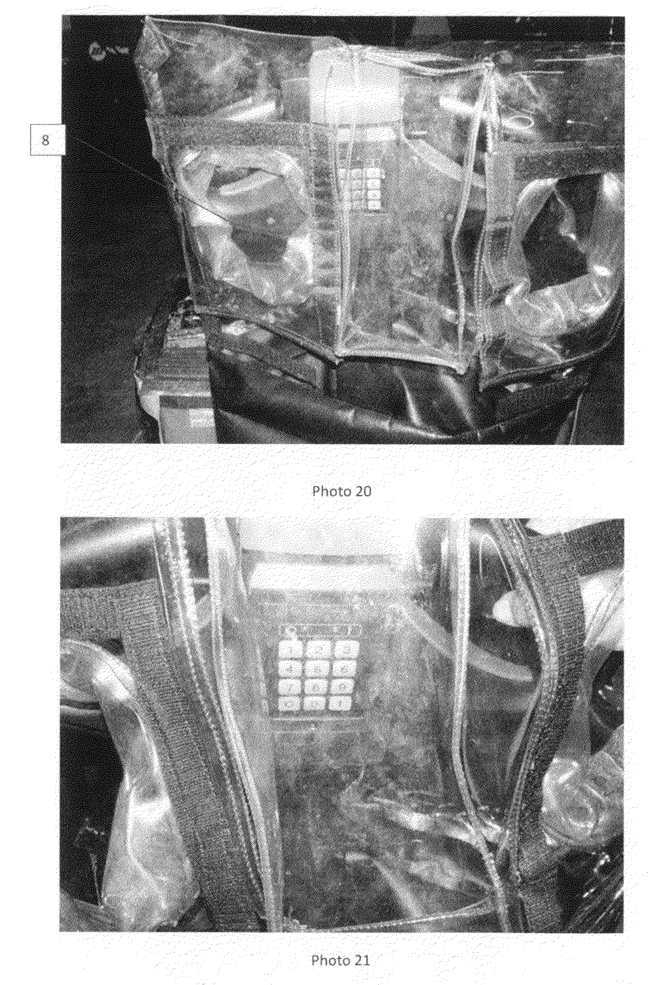

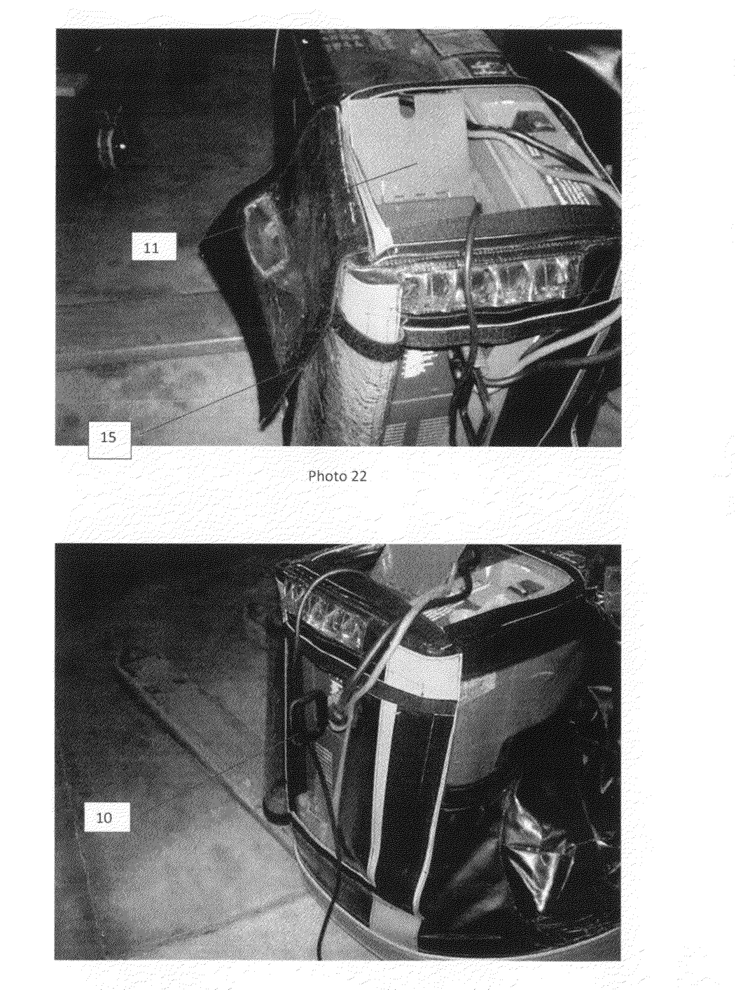

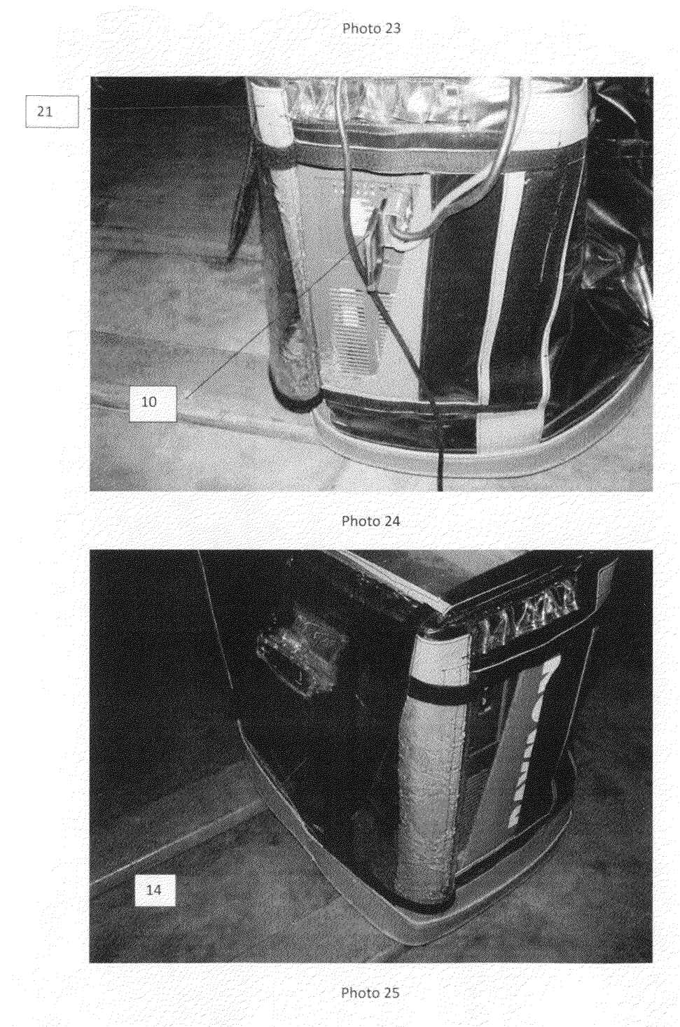

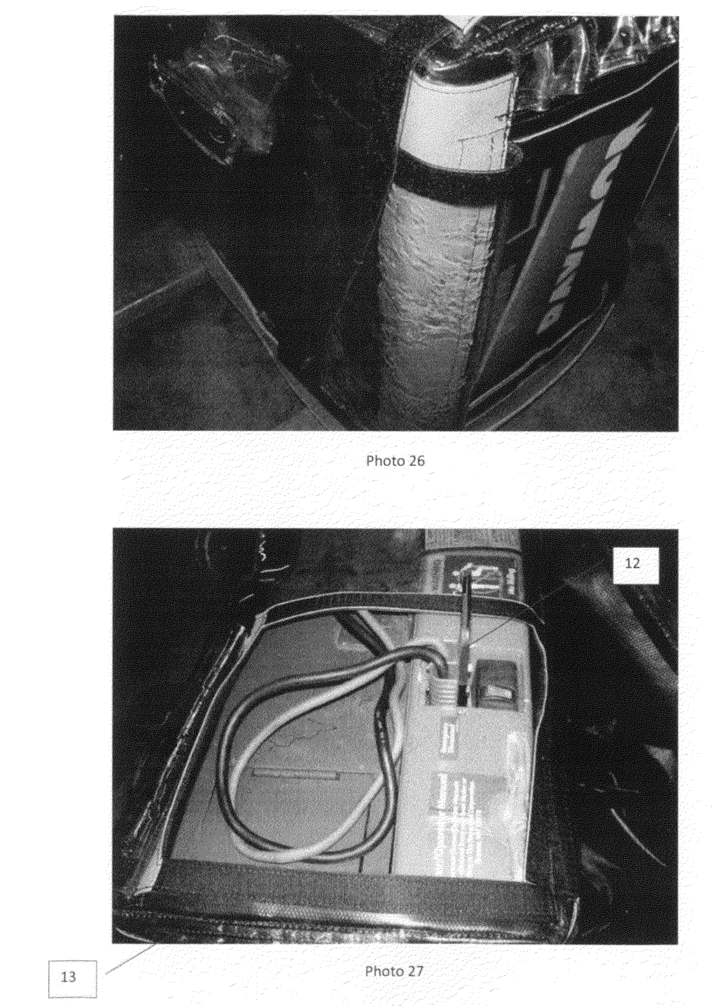

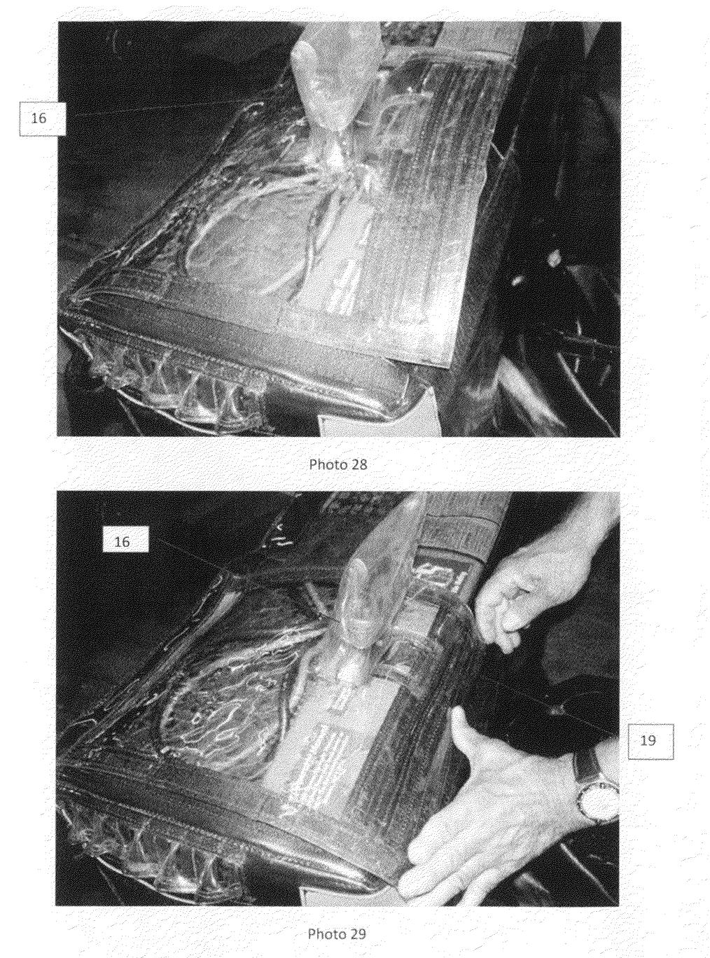

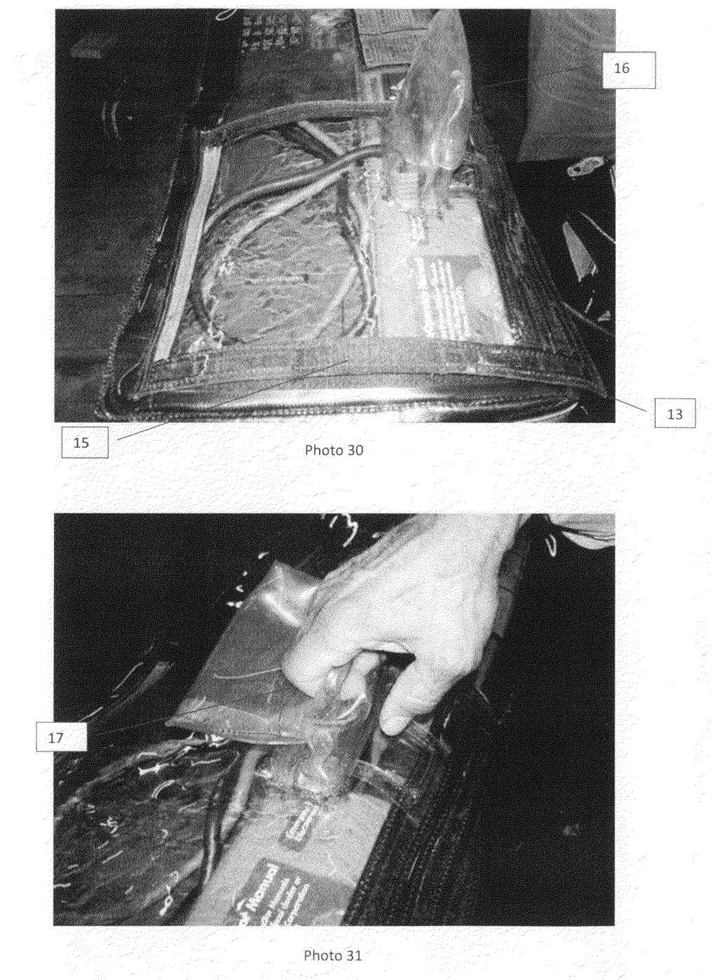

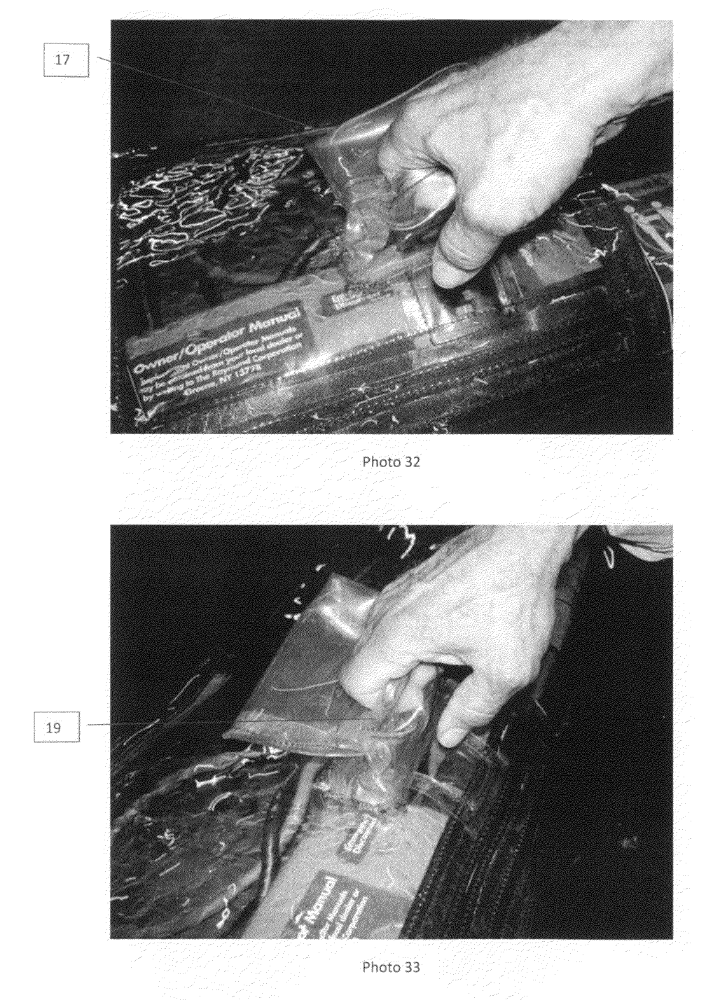

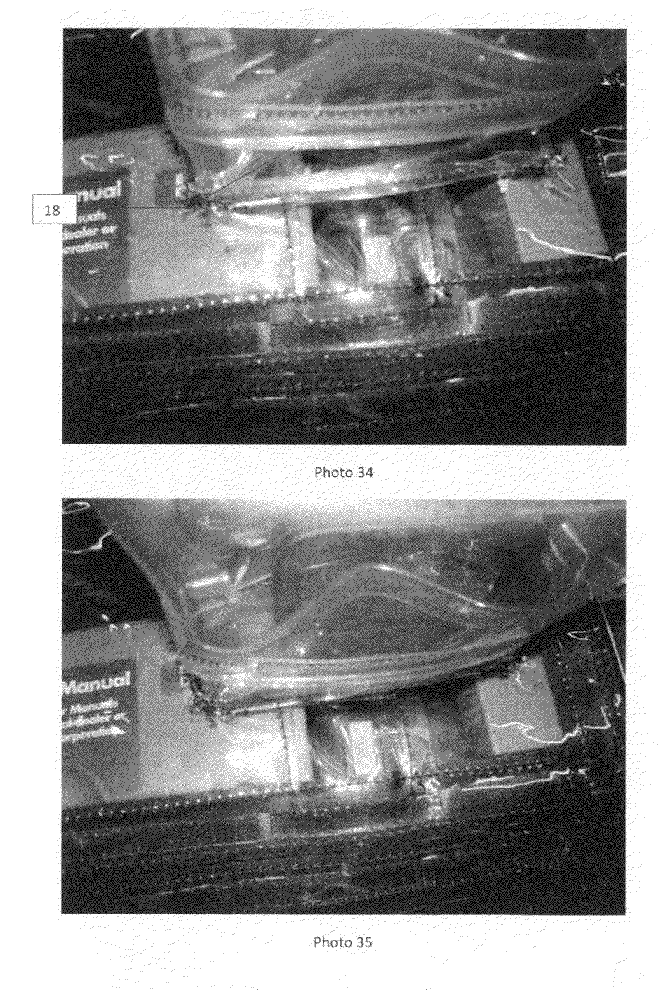

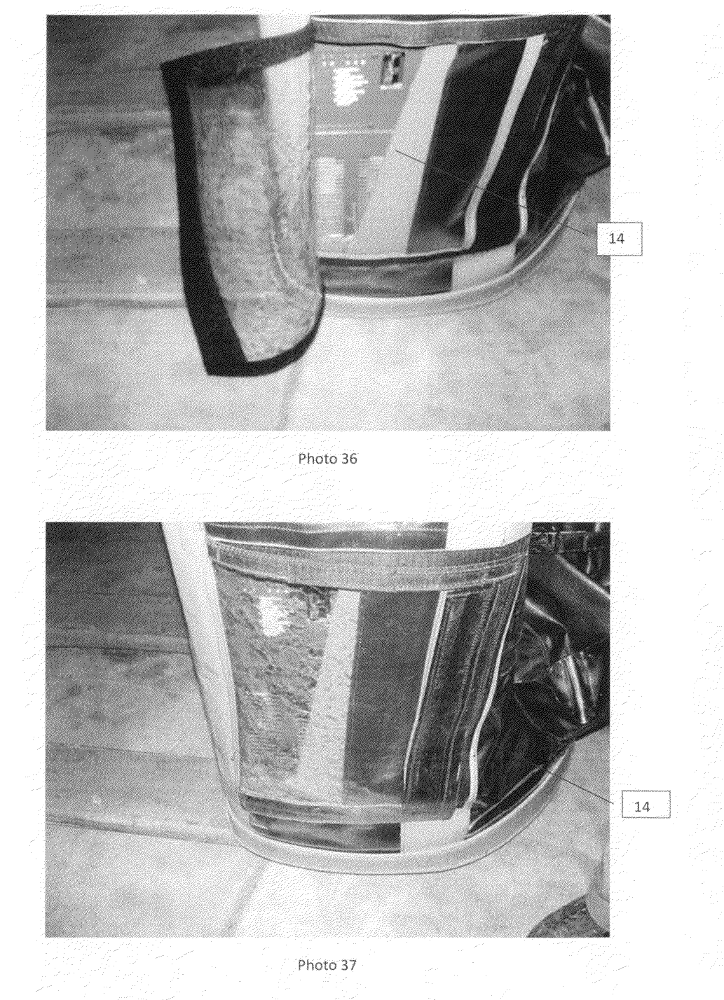

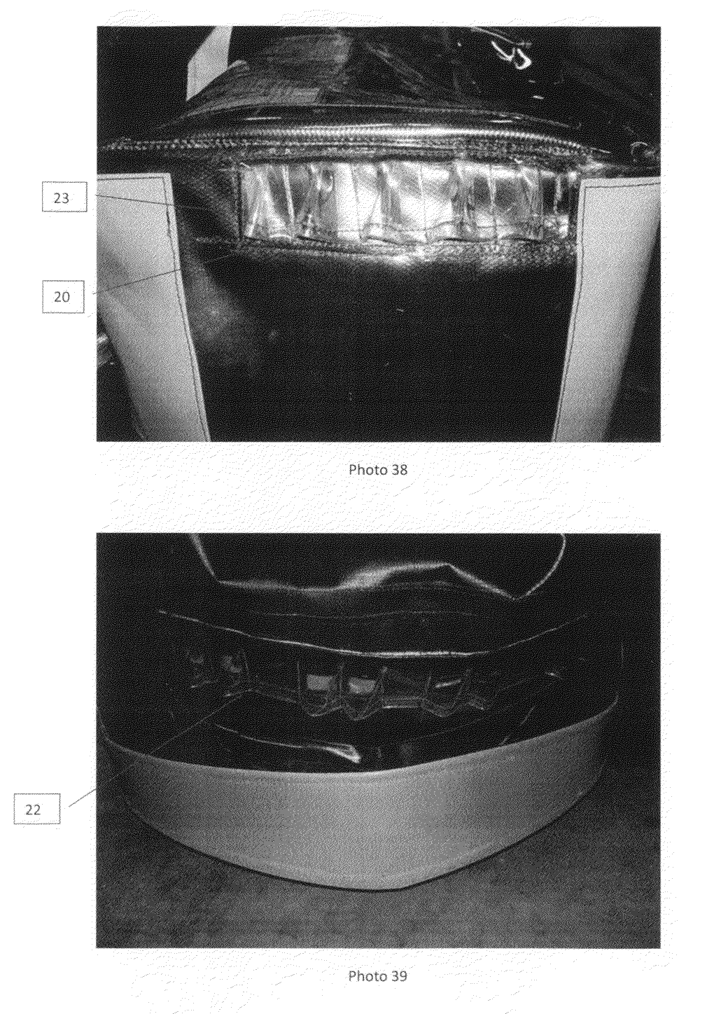

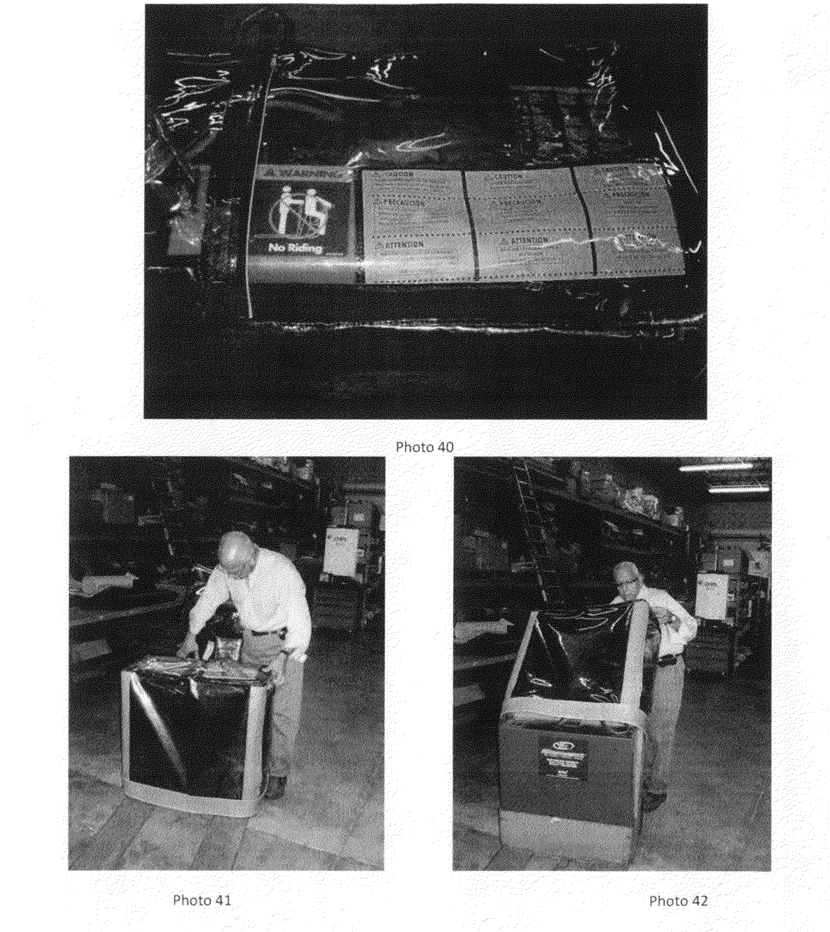

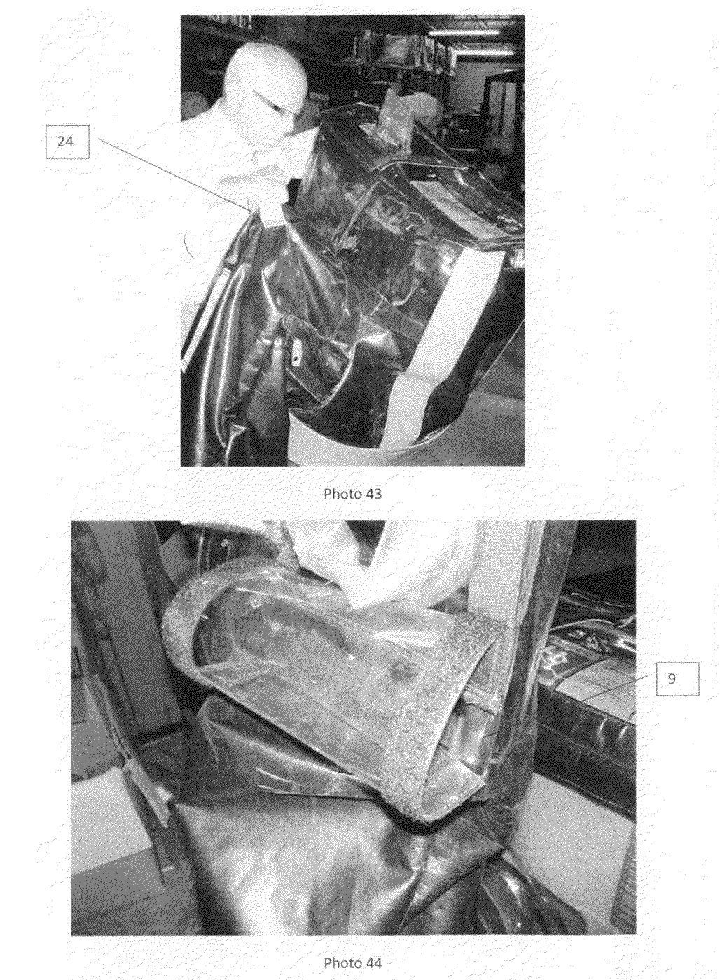

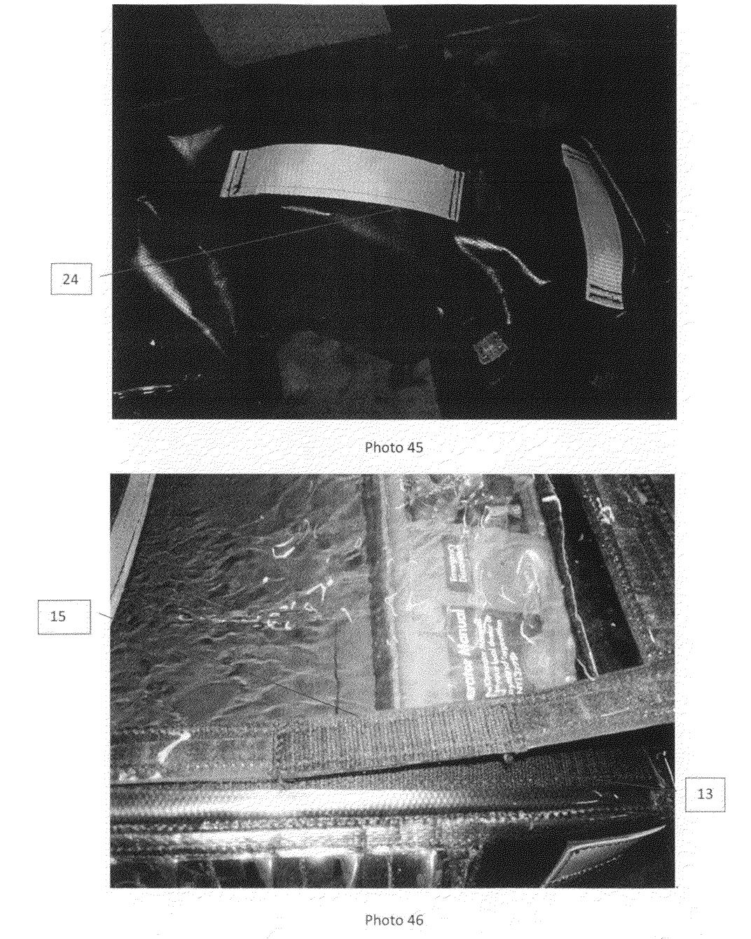

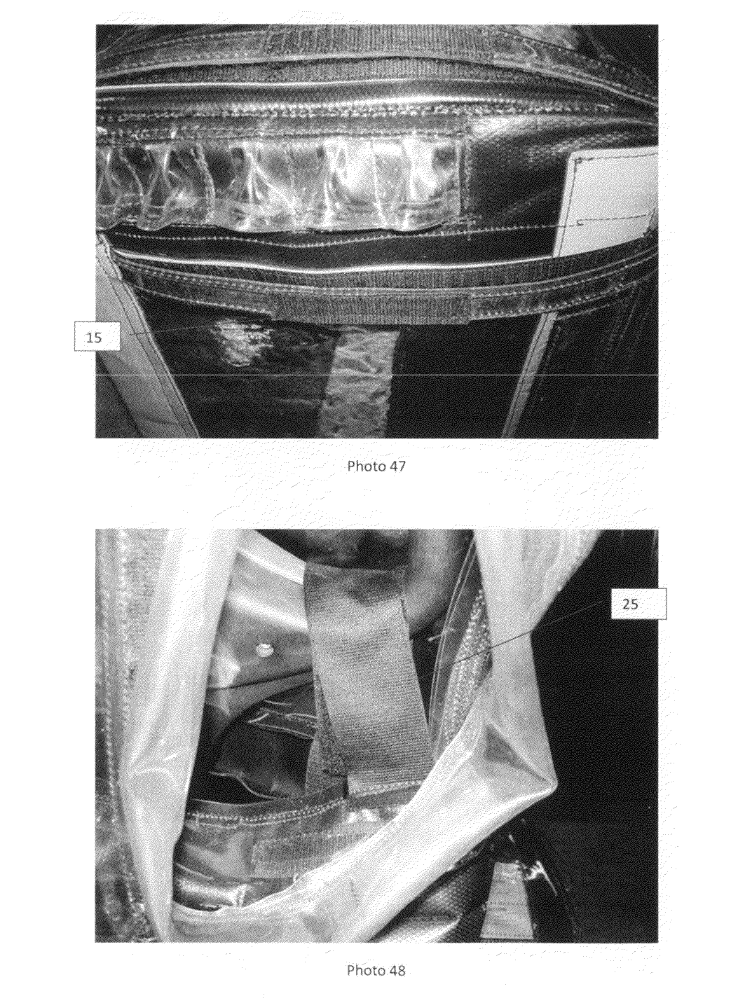

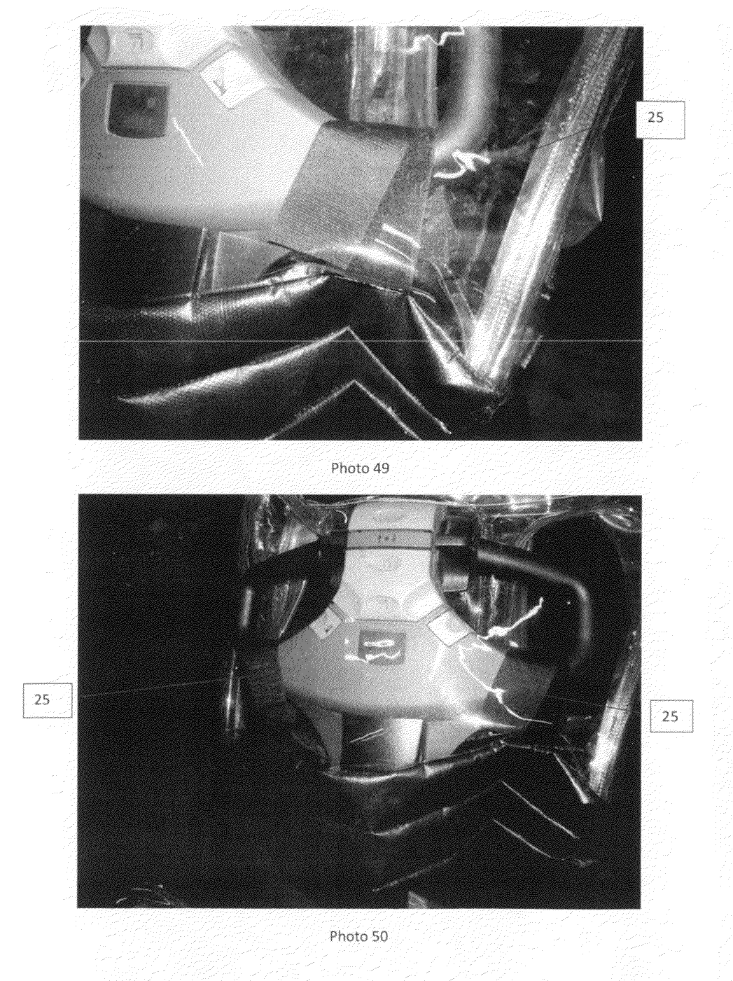

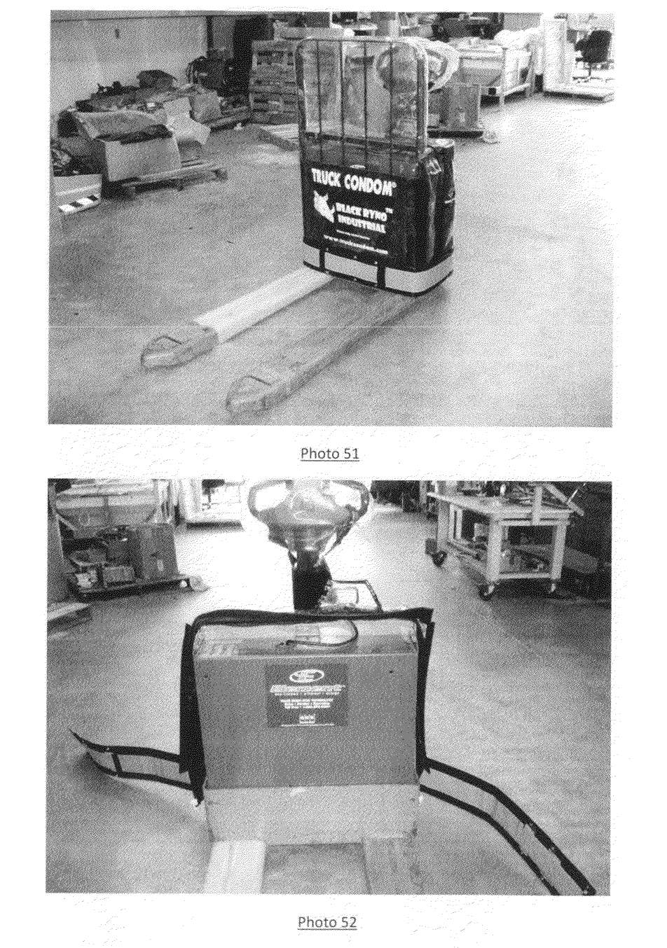

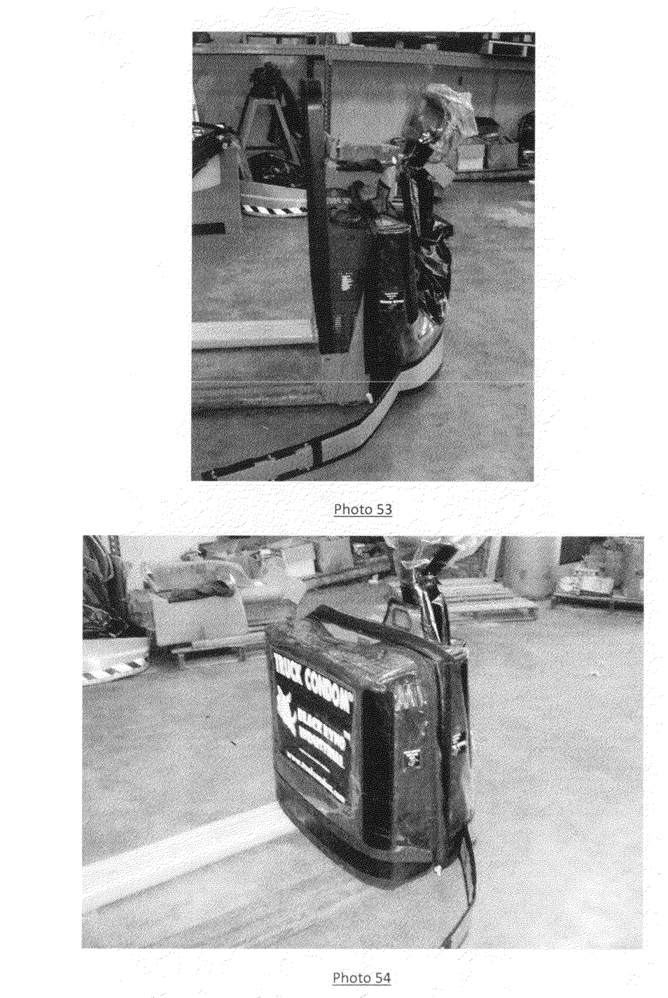

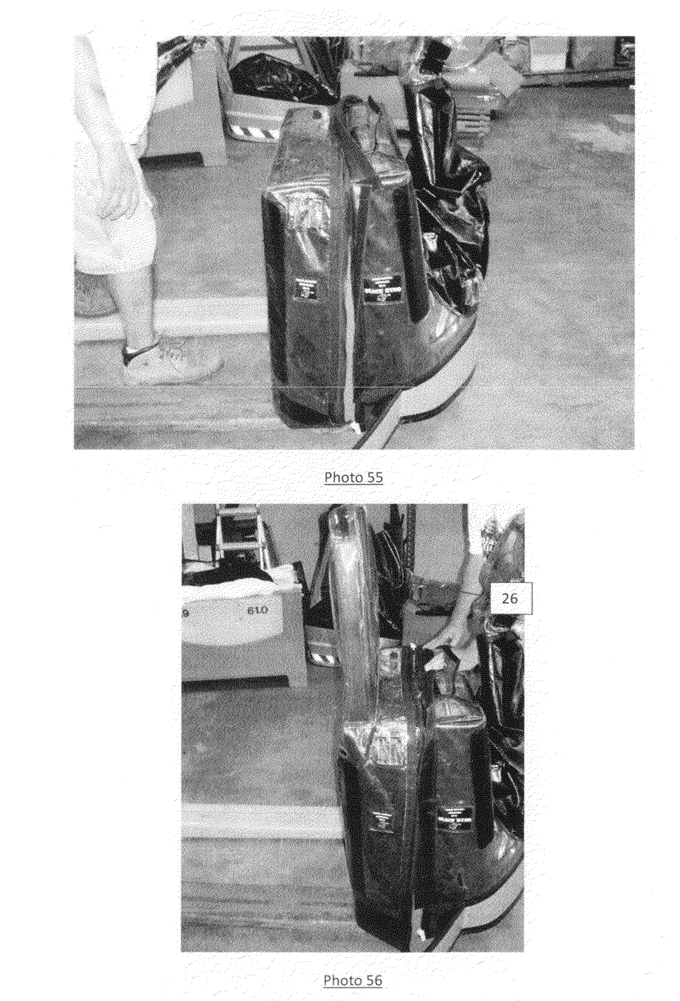

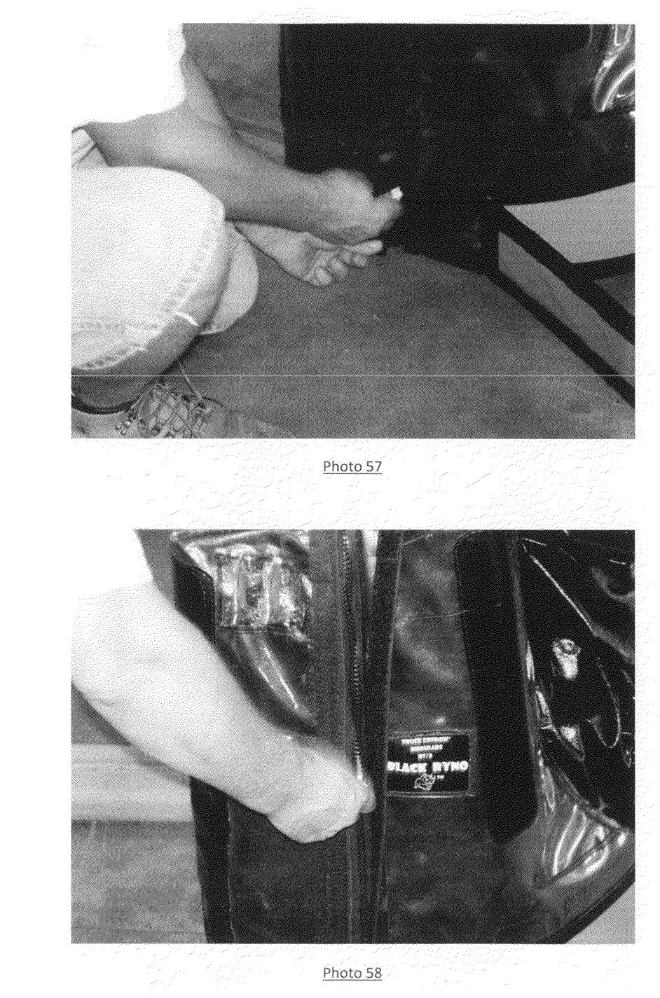

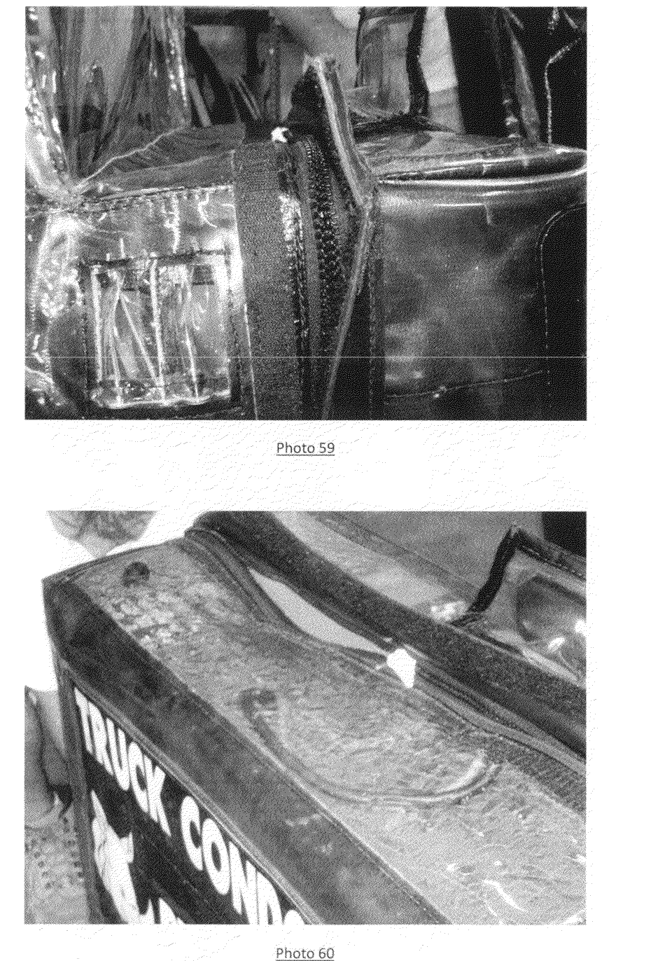

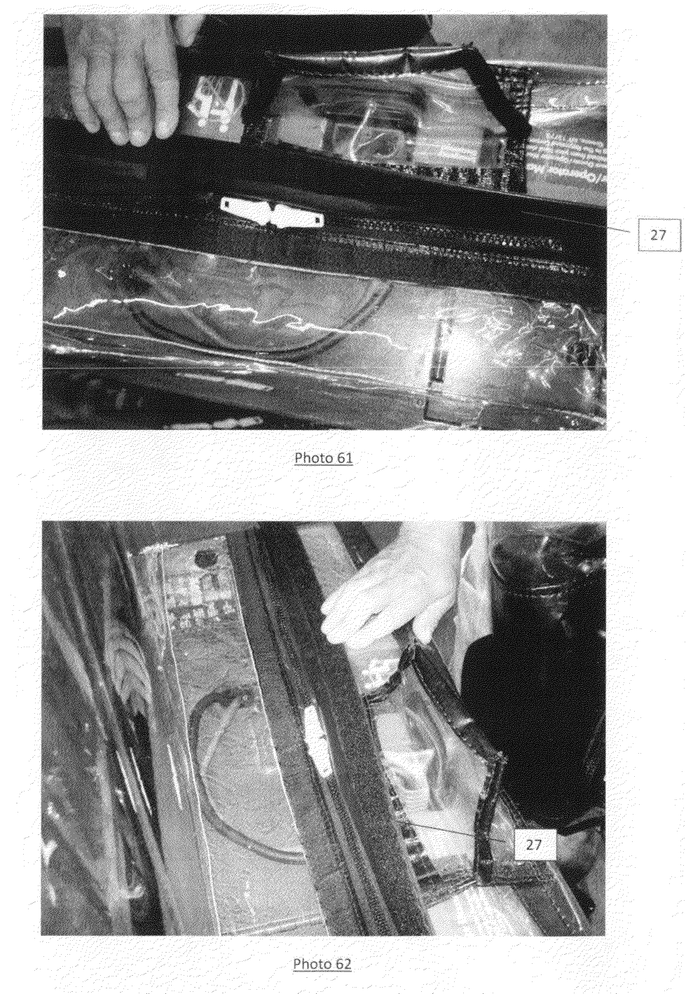

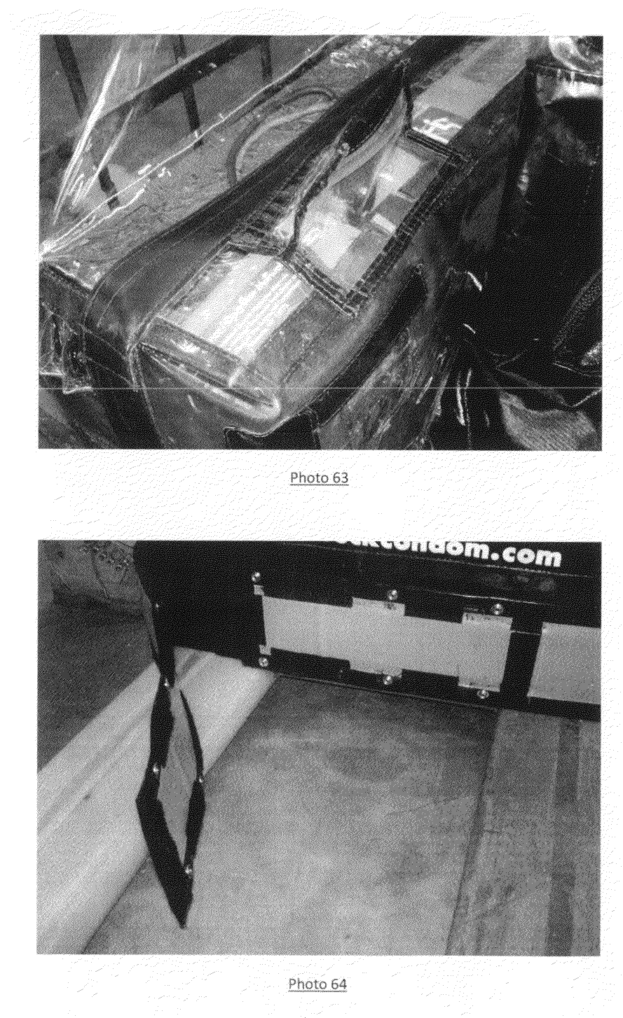

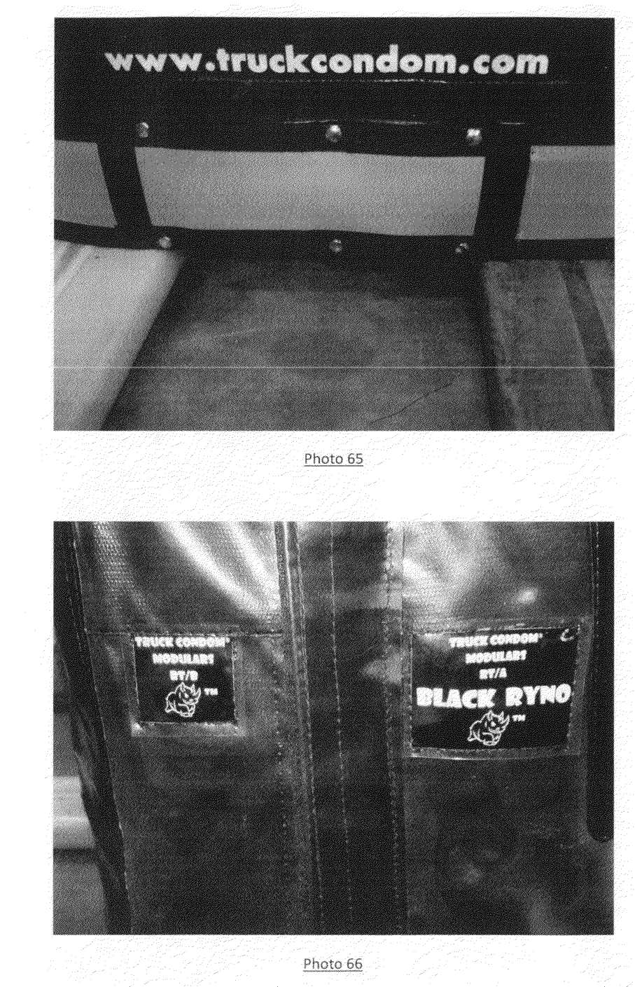

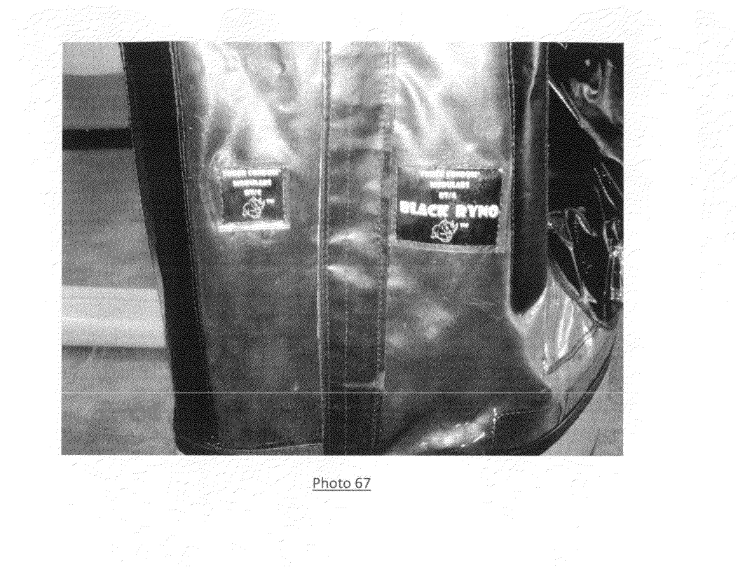

### FIELD OF THE INVENTION

This invention relates to a cover for material handling equipment and more particularly to powered pallet jacks/trucks that are manufactured by numerous Companies world-wide. This cover allows for all functional operations to occur (steering, lift, propulsion, keyless entry lockout, emergency battery disconnect, emergency operator push-off, battery charging) with the cover on the unit.

### BACKGROUND OF THE INVENTION

In the production and shipping of articles, it is well known to have machinery commonly referred to as material handlers to ease the process of moving units or bulk material. Material handlers include a broad range of equipment including conveyors, feeders, cranes, hoppers, stationary lifts and portable lifts such as pallet jacks and powered pallet jacks/trucks. Portable lifts are designed to raise and lower fork tines that are part of the lift and allow objects or containers that contain bulk materials to be on top of these moving fork times—lifting the items off the ground, and then transport them as needed for processing. Powered pallet jacks do the lifting and transporting via battery power and all electrical components are mounted in various locations on the body of the machine.

The level of cleanliness and safety of the electronics of the powered pallet jack/truck is typically dependent on the location in which the material handler is used. In certain environments, such as laboratories, the environment is generally clean and dry. In places such as warehouses, chemical processing facilities and food processing facilities the powered pallet jack/truck faces potential hazards to its electrical system from the weather if it is used outdoors, if corrosive chemicals or even water is used for processing or cleaning.

The lost work time of the powered pallet jack/truck, costs of repairs, and shorter use life of the unit itself due to this abuse is a significant issue that has faced the pallet jack/truck industry since the onset of the product line.

It has been recognized that reducing to a minimum the exposure of the electric components to any hazards would reduce the amount of down time when a unit would not be workable and adversely affect productivity, as well as prevent the costs of unexpected maintenance or the need to replace the equipment quicker than if the powered pallet jack/truck were in a clean environment.

It is desired to have a cover that protects the electrical components of a powered pallet jack/truck while still allowing the pallet jack/truck to be used.

### SUMMARY OF THE INVENTION

The invention relates to a cover that completely envelopes the battery, electrical components and drive/steering handle of the pallet jack/truck. This cover has several access points—which can be sealed when not in use. The access points exist to allow various operations such as steering control, propulsion control, on/off switches, keypad controls, battery cables and emergency shut-off controls.

In a preferred embodiment, the materials of construction of the cover is a combination of plastic and rubber parts, with some of the plastic at the tops and sides of the cover being transparent so that an operator can see all important aspects of the machine while allowing ‘hands on’ the actual controls within the cover via various access panels. The bottom of the unit is reinforced with heavier materials as the bottom the unit will take more abuse from the work environment.

One object, feature and advantage of the invention are the access panels, which when not in use are closed up with Velcro® or a similar sealing device. Another advantage is the modular construction of the cover which allows for similar pallet jack/trucks to use standard items like backrests or non-standard batteries or if the front section of the cover gets damage from use—having the end users only needing to change a portion of the cover.

Further objects, features and advantages of the present invention will become more apparent to those skilled in the art as the nature of the invention is better understood from the accompanying photos and detail descriptions.

### BRIEF DESCRIPTION OF PHOTOS

For the purpose of illustrating the invention, there is shown in the photos a form which is presently preferred; it being understood, however, that this invention is not limited to the precise arrangements and instrumentalities shown.

Photo 1 is a typical pallet jack/truck with no cover from the back

Photo 2 is a typical pallet jack/truck with no cover from the front

Photo 3 is a typical pallet jack/truck with no cover showing the top view of the batteries and battery cables.

Photo 4 is a typical pallet jack/truck with no cover showing the top/front of the steering handle

Photo 5 is the pallet jack/truck with the cover on from the back with all access panels closed

Photo 6 is the pallet jack/truck with the cover on from the right side

Photo 7 is the pallet jack/truck with the cover on from the left side with all access panels closed

Photo 8 is the pallet jack/truck with the cover on from the front with all access panels closed except for the hand control access panels as the operator is using the throttles on the pallet jack/truck along with turning the handle to steer the machine.

Photo 9 is the pallet jack/truck with the cover on from the back with all access panels closed except for the hand control access panels as the operator is using the throttles on the pallet jack/truck to propel the machine.

Photo 10 is the pallet jack/truck with the cover on from the back with all access panels closed except for the hand control access panels as the operator is using the throttles on the pallet jack/truck a to propel the machine.

Photo 11 is the pallet jack/truck with the cover on from the back with all access panels closed except for the hand control access panels as the operator is using only one hand on one of the throttles on the pallet jack/truck along with turning the handle to steer the machine.

Photo 12 is the steering handle with the operator's hands inside via the access panels.

Photo 13 is the steering handle with the operator's hand inside via the access panel—front view

Photo 14 is the steering handle with the operator's hand inside via the access panel—front view

Photo 15 is the steering handle with the operator's hand inside via the access panel—front/side view

Photo 16 is the steering handle with the operator's hand inside via the access panel—back view

Photo 17 is the steering handle with the operator's hand inside via the access panel—back view

Photo 18 is the steering handle with the operator's hand inside via the access panel on the keypad—back view

Photo 19 is the steering handle from the back showing a keypad and the red safety push off at the top of the handle, all fully encased by the cover.

Photo 20 is the steering handle from the back showing a keypad and the red safety push off at the top of the handle, all fully encased by the cover.

Photo 21 is the steering handle from the back showing a keypad and the red safety push off at the top of the handle, all fully encased by the cover.

Photo 22 is the pallet jack/truck having its batteries charged via the built-in battery charger. Two access panels on the cover are open that are needed to be open to do the charging as well as allow proper, safe ventilation.

Photo 23 is the pallet jack/truck having its batteries charged via the built-in battery charger. Two access panels on the cover are open that are needed to be open to do the charging as well as allow proper, safe ventilation.

Photo 24 is the pallet jack/truck having its batteries charged via the built-in battery charger. Two access panels on the cover are open that are needed to be open to do the charging as well as allow proper, safe ventilation.

Photo 25 are the two access covers (side and top) attached to each other via a fastener like Velcro® or snaps to make sure they stay fully open.

Photo 26 are the two access covers (side and top) attached to each other via Velcro® to make sure they stay fully open during charging.

Photo 27 is the pallet jack/truck after having its batteries charged via the built-in battery charger. The wires are moved from the charger to the plug that powers the pallet jack/truck.

Photo 28 starting to close the access panel on the top of the pallet jack/truck after the power cable has been connected

Photo 29 closing the access panel on the top of the pallet jack/truck after the power cable has been connected

Photo 30 the access panel on the top of the pallet jack/truck completely closed, sealed via Velcro® or alternative Fastener on three sides.

Photo 31 is showing the operator pulling out the emergency battery cutoff switch through an access slot on the closed cover.

Photo 32 is showing the operator pulling out the emergency battery cutoff switch through an access slot on the closed Cover to allow actual ‘hands on’ to the emergency cut-off switch.

Photo 33 is showing the operator pulling out the emergency battery cutoff switch through an access slot on the closed cover.

Photo 34 view of the emergency battery disconnect as well as the red on/off switch encased via the flip cover that is made from a soft pliable plastic to allow access while remaining a sealed area, encased via an overlapping pocket front panel

Photo 35 view of the emergency battery disconnect as well as the red on/off switch.

Photo 36 the side access panel fully open that allow the battery charger to be used with full venting.

Photo 37 the side access panel fully closed, sealed via fastener on three sides.

Photo 38 showing the upper vents on the side of the cover to provide water shielding vents, while still allowing air flow.

Photo 39 showing the lower vents on the back of the cover to provide water shielding vents, while still allowing air flow to and from the drive motor.

Photo 40 showing the tri-lingual safety warnings

Photo 41 is showing the operator starting to take the cover off using the side vents as handles.

Photo 42 is showing the cover being removed.

Photo 43 is showing the operator holding the removed cover

Photo 44 showing the Velcro® frame around the hand access panel. There is Velcro® on both sides of the panel cover so that it may be attached to the cover to stay open.

Photo 45 showing handle straps on the back of the steering handle portion of the cover to aid with removal of the cover.

Photo 46 showing Velcro® on both sides of the top access panel so that it may be attached to the side cover to keep both panels fully open.

Photo 47 showing the Velcro® on both sides of the top access panel so that it may be attached to the side cover to keep both panels fully open.

Photo 48 showing the internal strap of the cover attached to the pallet jack/truck handle to keep the handle portion of the cover in proper orientation from the front view.

Photo 49 showing the internal strap of the cover attached to the pallet jack/truck handle to keep the handle portion of the cover in proper orientation, from the back view

Photo 50 showing the complete upper cover handle with both internal straps on the handle.

Photo 51 showing the cover on a pallet jack/truck that has a backrest.

Photo 52 showing the back section of the modular cover on.

Photo 53 showing the back section of the modular cover on.

Photo 54 showing the two sections of the modular cover on the pallet jack/truck but not zipped up.

Photo 55 showing the two sections of the modular cover on the pallet jack/truck but not zipped up.

Photo 56 showing the two sections of the modular cover on the pallet jack/truck but not zipped up.

Photo 57 showing the zipper being closed by an operator.

Photo 58 showing the zipper being closed by an operator.

Photo 59 showing the zipper closed, protective strip open.

Photo 60 showing half the zipper closed and the other half open.

Photo 61 showing the zippers closed with the protective strip being held open for viewing purposes.

Photo 62 showing the zippers closed with the protective strip being held open for viewing purposes.

Photo 63 showing the zippers covered by a protective strip.

Photo 64 showing the bottom bumper in an unlatched position.

Photo 65 showing the bottom bumper in a closed position.

Photo 66 showing the modular decals with an ‘A’ component and a ‘B’ component.

Photo 67 showing the modular decals with an ‘A’ component and a ‘C’ component.

### DETAILED DESCRIPTION OF THE INVENTION

Referring to the photos in detail, where numerals indicate like elements, there is the invention 1 in Photo 5 showing the cover from the back, Photo 6 from the right side, Photo 7 from the left side, Photo 8 from the front.

The materials of construction are a clear/semi-clear UHMW polyethylene and PPVC on the access panels as well as the top of the handle; black scrim for most of the body of the lift, yellow UHMW polyethylene cover reinforcements and a bottom bumper made of recycled rubber. Access panels are secured using Velcro®.

The portion of the cover that envelopes the handle 2 is shown in Photo 9 with an operator operating the throttle controls of the pallet jack/truck through the hand access panels and again in Photo 10. The hand access panels are the only openings on the cover while the unit is use so that the electronics system—the battery, battery charger, on/off switch, propulsion controls, lift/lower controls, safety controls, etc. are protected from the work environment. The work environment would typically have one or several elements that would damage the electrical system: water, corrosive chemicals, sand, and food particulates.

The cover specifically allows full access to use all the handle functions by providing the re-sealable access panels 6, as shown in Photo 17, as well as using clear plastic material in this portion of the unit so that the operator can see the controls as well. The clear material 4 is demonstrated in Photo 12, Photo 13 and Photo 14.

The design of the handle portion of the cover includes clear flexible material near the top as shown in Photo 17 so that the cover does not interfere with functionality of the red safety switch 5 at the top of the handle.

The clear material at the top of the handle portion of the cover also allows viewing of security lock out systems like keypads 7 and key switches that are typical of the pallet jack/trucks as shown in Photo 18 and Photo 19.

There are two straps 25, one on each lower part of the hand hold on the handle, that locate the cover in the proper orientation for ease of use by the operator as shown in Photo 48, Photo 49, and Photo 50. These straps keep the handle from interfering with the controls and diminishes the potential for the weight of the cover to rest on an operator's hands while the operator is using the controls on the handle.

When the pallet jack/truck does not need the controls to be accessed, the access covers are put back in place 8 as shown in Photo 20. The access covers are made of the same clear plastic with a border of Velcro® that creates a secure seal from the access cover to the main portion of the cover. When the operator wants to use the controls in the handle, he/she pulls the access cover open from the top and secures the access cover 9 open via Velcro® to the outside of the main cover as shown in Photo 44. With the access flap covers in place the hand holes are sealed against moisture and corrosion. The entire truck, including the handle can be washed down with no potential damage to the electrical components.

Another area that requires access is the portion on the main body of the pallet jack/truck that has the batteries and battery charger. Each pallet jack/truck has an electrical system that connects the batteries to the pallet jack/truck with a quick-disconnect wiring arrangement. When the batteries need to be charged, the quick-disconnect wires are moved from a connection plug on the pallet jack/truck to a similar connection plug on the battery charger.

Depending on the Manufacturer of the pallet jack/truck, the location of the batteries, charger and the quick-connect points vary. The cover, and designated access panels are built to accommodate the various pallet jacks that are produced.

In Photo 22, Photo 23, and Photo 24, this model pallet jack/truck has the access to the battery charger with its quick-disconnect port on the left side 10, with the batteries on the right side with the wires from the batteries on the top of the pallet jack/truck 11 and the quick disconnect port to power the unit on top of the lift 12 as shown in Photo 27.

Two access panels have been provided to allow access to the battery charger and batteries/quick disconnect port. As with the hand access ports, the access panels have a Velcro® border to seal them shut 13 as shown in Photo 27, Photo 30, Photo 46 and Photo 37.

When the battery and battery charger covers are opened 14 as shown in Photo 36, they are secured against each other with a portion of Velcro® that is on the outside of the access panels 15 as shown in Photo 22, Photo 25, Photo 30, Photo 37, Photo 46 and Photo 47.

The top access panel cover 2 has a special provision for the handle of the quick-disconnect wires 16 as shown in Photo 28, Photo 29 and Photo 30. The special provision is a clear sleeve that has a split for hand access 17 as shown in Photo 31 and 32, in the middle of one side. The unit is constructed so that the two portions of the sleeve overlap over the split 18—to prevent any items from the work environment to seep in as shown in Photo 34. When the operator needs to use the quick disconnect, he/she reaches into the split, grabs the handle and pulls up. The split is sized to allow the handle to come through entirely—keeping with the safety intent of having a quick electrical shutoff of the unit 19 as shown in Photo 33.

There are also three (3) venting areas on the unit. The vents are on the upper part of the left 21 as shown in Photo 24 and right side 20 as shown in Photo 38 of the cover as well as the lower/back of the cover under the handle portion 22 as shown in Photo 39. These vents are specifically located to release any heat or gas buildup that may occur in the normal use of the machine at the batteries and propulsion motor. The vents are constructed of clear plastic in semi-circular loops. There is backing material made of scrim with holes in it to allow for the air flow. The cuts in the scrim do not go to the opening of the vents 23 as shown in Photo 38—thus avoiding the possibility of items from the work environment to seep in.

The cover is designed to be put on and taken off by one person as shown in Photo 41, Photo 42 and Photo 43. There are strap handles on the back side of the handle portion of the cover 24 as shown in Photo 43 and Photo 45 to aid the handling of the cover. The top flap is also used as an aid to putting off and on the cover with the flap in an open position.

The cover is made in modular components as certain sections, such as the portion with the steering handle are identical in numerous pallet jack/truck models, to give the end user flexibility to change out portions of the cover. Reasons for changing out portions of the cover range from a change in the battery being used, addition of a backrest, physical damage to the portion of the cover, etc. Photo 52 and Photo 53 show the back section of the cover, which protects the steering handle and internal electronics of the pallet jack/truck, in place. Photo 54 and Photo 55 show a front modular section placed on the pallet jack/truck, but the two modular components are not currently secured to each other. Photo 56 shows a front modular section 26 that allows for a backrest on the pallet jack/truck. Again, the two modular components are not currently secured to each other.

The modular components are secured to each other using a zipper arrangement that uses two zippers on a common track. Photo 57 shows an operator starting to zip the two modular components together. Photo 58 shows the continued progress of the zipper being closed up the side of the components. Photo 59 shows one of the zippers on the top of the components with the zipper track secured together.

The inclusion of a second zipper on a single zipper track makes it easier to connect the components by forcing the operator to align the components before zipping begins and also acts as a redundant system that does not cause the cover to be non-functional if one of the zippers on the track were to break as the second zipper is equipped to handle the entire track. Photo 60 shows one of the zipper at the half-way point in securing the cover, with the second zipper not yet zipped up completely.

Photo 61 and Photo 62 show the two zippers abutting each other at the top of the cover, with the two modular components now completely secured. There is a protective strip 27 that covers the entire length of the zipper track. The strip is being held open by an operator. This strip is made of fabric and secured with Velcro®. The strip, when closed, keeps dirt and debris off the zipper track as shown in Photo 63.

The bumper at the bottom of the cover is permanently connected to the back modular section that covers the steering handle, as shown in Photo 52, Photo 53, Photo 54. Once the two modular sections are secured via the zippers, the bumper is wrapped around the front of the front modular section as shown in Photo 64 and Photo 65. The bumper may overlap and be secured with snaps, Velcro® or other similar fastening devices. Alternatively, the bumper sections may just secure to the front of the front modular component without overlapping each other.

The modular components have corresponding nameplates to aid in matching up compatible parts. Photo 66 shows an example of ‘RT/A’ matching with ‘RT/B’ and Photo 67 shows an example of ‘RT/A’ matching with ‘RT/C’. Other models names exist with similar patterns.

1. A cover made up of numerous plastic and recycled rubber materials made to protect the controls and electronics of a rechargeable powered pallet jack/truck. These powered pallet jack/trucks are made by various Companies.

2. A cover as in claim 1, where the top of the cover is made of transparent and translucent plastic material to allow the operator to view the controls and safety equipment on the powered pallet jack/truck.

3. A cover as in claim 1, where heavy duty recycled rubber material is used on the bottom of the unit.

4. A cover as in claim 1, where elastic may be used around the base of the steering handle and other places as necessary to create a more precise fit.

5. A cover as in claim 1, where sealable access points exist in various positions on the cover, depending on the make and model of the powered pallet jack/truck. These re-sealable points may use various fasteners such as Velcro® or snaps and provide the same water tight protection of the solid portions of the cover.

6. A cover as in claim 1, that has position orienting straps internal to the handle section which align the handle section of the cover for safe and ergonomic use by the operator.

7. A cover as in claim 1, that has re-sealable access points on the cover to avoid having to remove the cover for use.
a. These access points may include, but are not limited to the following features
i. Steering handle
ii. Throttle controls for propulsion
iii. Keypad or key switch for power
iv. Emergency shut off switch
v. Emergency battery cut off switch
vi. Horn
vii. Emergency push off switch
viii. Battery charger or charging cables

8. A cover as in claim 1, that allows full and complete functionality of the pallet jack/truck while the cover is on, with the intent that the cover not need to be taken off under normal conditions.

9. A cover as in claim 1, that has vent/louvers to keep liquids out from inside the cover but allow heat and/or gas disbursement. These vent/louvers also provide handles for ease in removing the cover.

10. A cover that is modular, containing at least two major components, secured together using a zipper or similar fastening components that allows for interchangeable front and back sections as needed by the model of pallet jack/truck being used.
